(19) United States
(12) Patent Application Publication
(10) Pub. No.: US 2025/0301086 A1
(43) Pub. Date: Sep. 25, 2025

(54) STORAGE MEDIUM STORING CONTROL PROGRAM FOR INFORMATION PROCESSING APPARATUS, CONTROL METHOD FOR INFORMATION PROCESSING APPARATUS, AND INFORMATION PROCESSING APPARATUS

(71) Applicant: CANON KABUSHIKI KAISHA, Tokyo (JP)

(72) Inventor: TAKU SHINOHARA, Saitama (JP)

(21) Appl. No.: 19/068,332

(22) Filed: Mar. 3, 2025

(30) Foreign Application Priority Data
Mar. 21, 2024 (JP) 2024-044636

(51) Int. Cl. H04N 1/028; H04N 1/00

(52) U.S. Cl. CPC H04N 1/02815; H04N 1/0048; H04N 1/00925

(57) ABSTRACT

A storage medium storing a control program for an information processing apparatus which is capable of allowing a user to use a light amount control function. A non-transitory computer-readable storage medium storing a program that supports a general-purpose program capable of commonly being used in scanning apparatuses of a plurality of manufactures and causes an information processing apparatus into which the program is installed to execute a method including displaying a setting screen on which a set state of a light amount in a scanning process is accepted, and outputting a command to cause a scanning apparatus to execute the scanning process with the set state of the light amount accepted on the setting screen.

### BACKGROUND OF THE INVENTION

### Field of the Invention

The present invention relates to a storage medium storing a control program for an information processing apparatus, a control method for the information processing apparatus, and the information processing apparatus.

### Description of the Related Art

There is a known configuration in which a scan driver installed in a host computer as software for controlling a scanning apparatus is used to instruct the scanning apparatus connected to the host computer to execute a scanning process. An OS (Operating System), which is basic software, is installed in the host computer, and the scan driver is configured in accordance with specifications defined by the OS and is called from the OS to operate. A manufacturer of the scanning apparatus can provide a means for instructing the scanning apparatus to execute scanning processing using the OS by providing a scan driver compatible with the specifications of the OS.

Incidentally, Windows (registered trademark) will provide a standard class driver (hereinafter, also referred to as a “standard driver”) that can be used in common for scanning apparatuses of a plurality of manufacturers. Such a standard driver is included in a package of the OS, and can be easily used by connecting an arbitrary scanning apparatus to the host computer. Therefore, it is not necessary to separately install a model-specific scan driver suitable for an individual scanning apparatus, which has high convenience. The standard driver is assumed to be able to designate a scan function based on scan function information of a scanning apparatus connected to the host computer. Thus, a user using the standard driver can designate the scan function corresponding to the capability of the scanning apparatus connected to the host computer, even when the user uses one standard driver. However, since usable scan functions are limited to functions that can be achieved by the standard driver, a function unique to a manufacturer cannot be designated. In contrast, a technique for using a function unique to a manufacturer is proposed in Japanese Patent Laid-Open Publication No. 2021-033526. This publication discloses a program that expands a print function of general-purpose print software.

Here, there is a light amount control function of a scanning apparatus as a function unique to a manufacturer. Light amount control function is a function of controlling a light amount when the scanning apparatus executes the scanning process. When a document is scanned darkly using the light amount control function, image data in a state where correction traces on the document due to correction liquid or correction tape are visually recognizable can be obtained. Further, when a document is scanned brightly using the light amount control function, image data that puts the correction traces out of sight can be obtained.

However, since the standard driver does not support the light amount control function, the host computer that instructs the scanning apparatus to execute the scanning process using the standard driver cannot allow a user to use the light amount control function.

### SUMMARY OF THE INVENTION

The present invention provides a storage medium storing a control program for an information processing apparatus, a control method for the information processing apparatus, and the information processing apparatus, which are capable of allowing a user to use a light amount control function.

Accordingly, an aspect of the present invention provides a non-transitory computer-readable storage medium storing a program that supports a general-purpose program capable of commonly being used in scanning apparatuses of a plurality of manufactures and causes an information processing apparatus into which the program is installed to execute a method including displaying a setting screen on which a set state of a light amount in a scanning process is accepted, and outputting a command to cause a scanning apparatus to execute the scanning process with the set state of the light amount accepted on the setting screen.

According to the present invention, a user is allowed to use the light amount control function.

Further features of the present invention will become apparent from the following description of exemplary embodiments with reference to the attached drawings.

### BRIEF DESCRIPTION OF THE DRAWINGS

FIG. 1 is a block diagram schematically illustrating a hardware configuration of a communication system according to embodiments.

FIGS. 2A and 2B are block diagrams schematically illustrating software configurations for a host computer in FIG. 1 to instruct a scanning apparatus to execute a scanning process.

FIGS. 3A to 3D are views illustrating examples of screens displayed on a display unit in FIG. 1.

FIG. 4 is a flowchart illustrating procedures of an editing control process executed by a scan function expansion unit in FIG. 2B.

FIGS. 5A to 5C are views illustrating examples of various types of information used by the scan function expansion unit in FIG. 2B.

FIG. 6 is a sequence chart illustrating procedures of a scan control process performed in the communication system in FIG. 1.

FIG. 7 is a flowchart illustrating procedures of a scan instruction command generation process executed by the expansion application in FIG. 2B.

FIG. 8 is a flowchart illustrating procedures of a control process performed by the scanning apparatus in FIG. 1.

FIG. 9 is a sequence chart illustrating procedures of a scan control process performed in a communication system according to a second embodiment.

FIG. 10 is a sequence chart illustrating a scan control process performed in a communication system according to a third embodiment.

FIG. 11 is a flowchart illustrating procedures of a scan instruction command generation process executed by an expansion application according to the third embodiment.

FIGS. 12A and 12B are views illustrating features of a fourth embodiment.

FIG. 13 is a view illustrating an example of a list of pieces of capability information obtained from the scanning apparatus by the host computer according to a fifth embodiment.

FIG. 14 is a flowchart illustrating a scan instruction command generation process executed by the expansion application according to the fifth embodiment.

FIGS. 15A and 15B are views illustrating examples of screens displayed on the display unit of the host computer according to the fifth embodiment.

### DESCRIPTION OF THE EMBODIMENTS

Hereafter, embodiments according to the present invention will be described in detail by referring to the drawings. The following embodiments do not limit the present invention defined by the scope of claims, and all combinations of features described in the embodiments are not necessarily essential to the solving means of the present invention.

First, a communication system, an information processing apparatus, and a control method for the information processing apparatus according to a first embodiment of the present invention will be described.

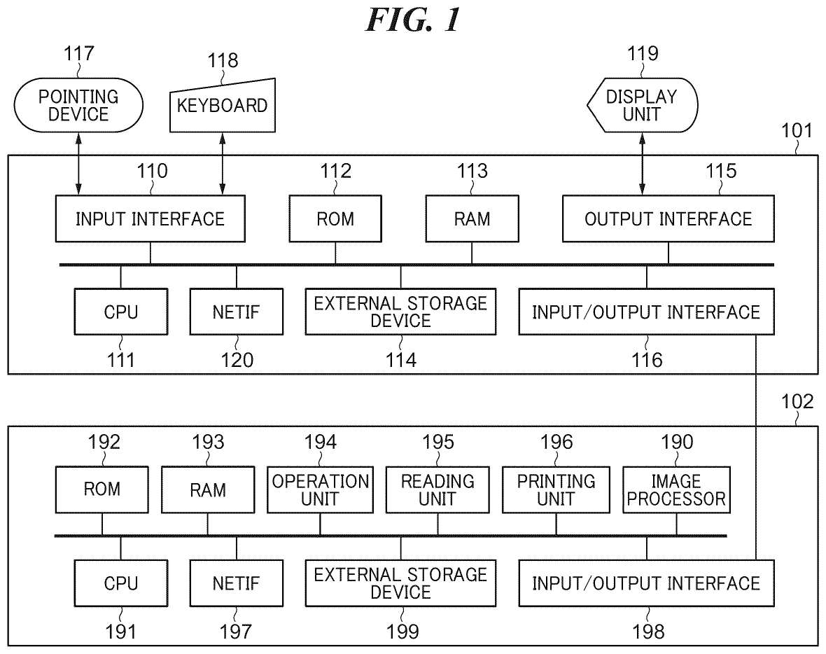

FIG. 1 is a block diagram schematically illustrating a hardware configuration of the communication system according to the present embodiment. As shown in FIG. 1, the communication system includes a host computer 101 and a scanning apparatus 102.

The host computer 101 is an example of the information processing apparatus and includes an input interface 110, a CPU 111, a ROM 112, a RAM 113, an external storage device 114, an output interface 115, and an input/output interface 116. The input interface 110 is connected to input devices such as a keyboard 118 and a pointing device 117, and the output interface 115 is connected to a display device such as a display unit 119. The host computer 101 further includes a NETIF 120. The NETIF 120 is a network interface and controls data communication with an external apparatus via a network (not shown).

The ROM 112 stores an initialization program. The external storage device 114 is, for example, an HDD (Hard Disk Drive) or an SSD (Solid State Drive). The external storage device 114 stores an application program group, an OS (Operating System), and other various data. The RAM 113 is used as a work memory when the program stored in the external storage device 114 is executed. In the present embodiment, the CPU 111 performs processes in accordance with codes of programs stored in the ROM 112, thereby executing functions of the host computer 101 described later and processes related to flowcharts described later.

The scanning apparatus 102 is an example of an image forming apparatus, and is connected to the host computer 101 via an input/output interface 198 of the scanning apparatus 102 and the input/output interface 116 of the host computer 101. The input/output interface 198 of the scanning apparatus 102 and the input/output interface 116 of the host computer 101 may be connected by a wired network or a wireless network.

The scanning apparatus 102 includes an image processor 190, a CPU 191, a ROM 192, a RAM 193, an operation unit 194, a reading unit 195, a printing unit 196, a NETIF 197, the input/output interface 198, and an external storage device 199.

The CPU 191 totally controls the scanning apparatus 102. The ROM 192 is a memory storing programs. The RAM 193 is a memory temporarily storing a program and image data. The reading unit 195 is a scanner and reads an image of a document to generate image data. The printing unit 196 prints an image on a sheet on the basis of the image data. Although the configuration in which the scanning apparatus 102 includes the printing unit 196 will be described in the present embodiment, the configuration of the scanning apparatus 102 is not limited to this configuration. For example, the scanning apparatus 102 may not include the printing unit 196. The NETIF 197 is a network interface and controls data communication with an external apparatus via a network (not shown). The image processor 190 performs various image editing processes on the input image data.

Although the host computer 101 and the scanning apparatus 102 are illustrated as separate apparatuses in FIG. 1, they may be configured as one information processing apparatus. In the present embodiment, an electrophotographic digital multifunction peripheral having a plurality of functions, such as copy, print, and FAX, is described as an example of the scanning apparatus 102, but the scanning apparatus 102 is not limited to the digital multifunction peripheral. The scanning apparatus 102 may be, for example, an apparatus using another process such as an inkjet method or a scanner that only reads an image. The host computer 101 may be a desktop personal computer, a smartphone, or a notebook personal computer.

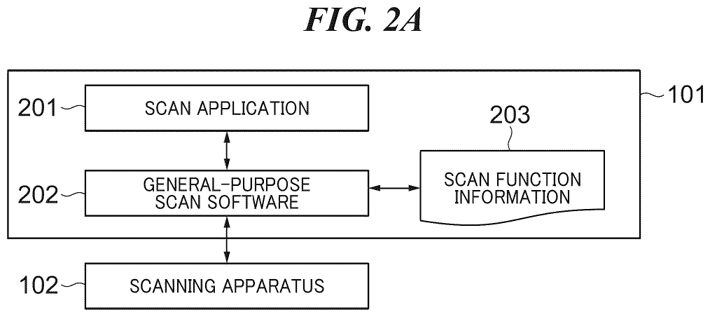

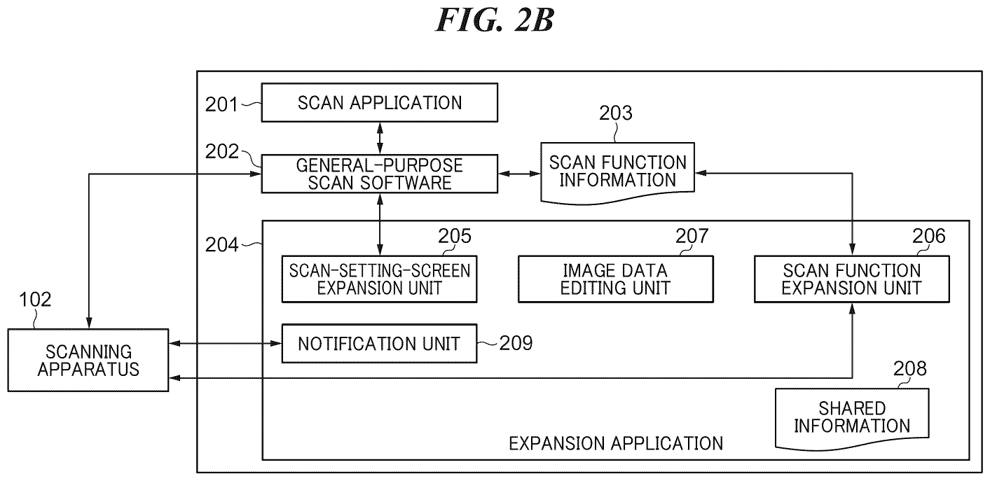

FIGS. 2A and 2B are block diagrams schematically illustrating software configurations for the host computer 101 in FIG. 1 to instruct the scanning apparatus 102 to execute a scanning process. In the present embodiment, the host computer 101 is assumed to be equipped with Windows (registered trademark) 11 of Microsoft (registered trademark) as the OS.

FIG. 2A illustrates a software configuration for the host computer 101, which does not include an expansion application 204, to instruct the scanning apparatus 102 to perform the scanning process.

As shown in FIG. 2A, the host computer 101 includes a scan application 201 and a general-purpose scan software 202 as software components for instructing the scanning apparatus 102 to execute the scanning process. The processes by these software components are achieved by the CPU 111 executing programs stored in the external storage device 114. The host computer 101 also includes scan function information 203.

The scan application 201 is software that captures a content (image data) generated by scanning a document, and is, for example, a document creation application or an image editing application. Upon receiving a scan request from the user, the scan application 201 issues a scan instruction to the OS of the host computer 101. The scan instruction includes scan setting information for instructing operations of the general-purpose scan software 202 and the scanning apparatus 102.

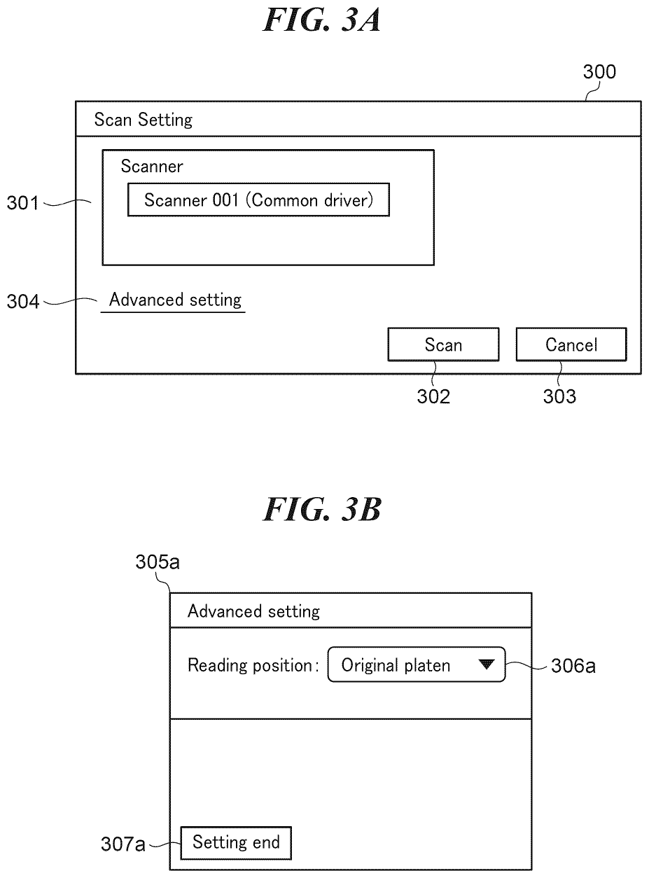

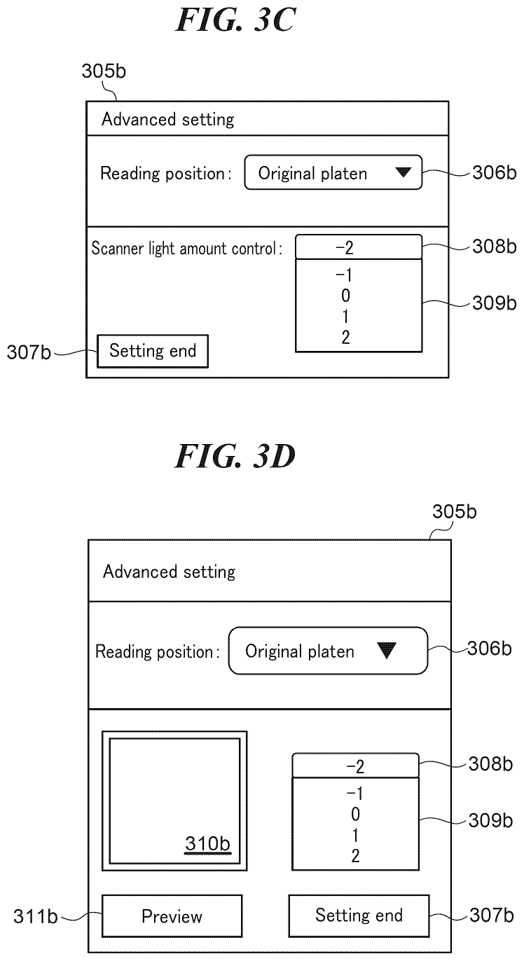

As a screen for accepting a scan request from a user, a scan setting screen provided by any of the general-purpose scan software 202, the OS of the host computer 101, and the scan application 201 is displayed on the display unit 119 of the host computer 101. When the user presses an advanced setting button on the scan setting screen, the general-purpose scan software 202 causes the display unit 119 of the host computer 101 to display an advanced setting screen. The configurations of the scan setting screen and the advanced setting screen will be described later with reference to FIGS. 3A to 3D. The advanced setting screen includes a setting item (hereinafter also referred to as a “control item”) indicating a scan function supported by the general-purpose scan software 202 and a control item indicating a set value of the scan function in accordance with the capability information of the general-purpose scan software 202.

The general-purpose scan software 202 is a general-purpose program that can be used in common for scanning apparatuses of a plurality of manufacturers, and is a general-purpose program that generates and outputs an instruction interpretable by the scanning apparatuses of the plurality of manufacturers. The general-purpose scan software 202 is a standard class driver that controls execution of a scanning process on the basis of a standard scan protocol called Mopria, for example. The general-purpose scan software 202 decides a scan capability on the basis of the scan function information 203.

The scan function information 203 is data that describes all scan functions supported by the general-purpose scan software 202, set values thereof, and exclusive relationships between the set values. The scan function information 203 is included in a configuration file of the general-purpose scan software 202, and is stored in the external storage device 114 as an unchangeable file. Alternatively, the scan function information 203 is dynamically generated by the general-purpose scan software 202 or the OS of the host computer 101. Specifically, the general-purpose scan software 202 or the OS of the host computer 101 obtains attribute data of the scanning apparatus 102 from the scanning apparatus 102, and generates the scan function information 203 on the basis of the obtained attribute data. The attribute data of the scanning apparatus 102 includes attribute information indicating functions (capabilities of the scanning apparatus) that can be designated in the scanning apparatus 102 and set values corresponding to the attribute information. The attribute data of the scanning apparatus 102 obtained from the scanning apparatus 102 is stored in the RAM 113. When the scan function information 203 is dynamically generated, the generated scan function information 203 can be edited.

By dynamically generating the scan function information 203 in this way, the general-purpose scan software 202 allows a user to designate a scan function that is supported by the general-purpose scan software 202 and that can be used in the scanning apparatus 102 connected to the host computer 101. That is, even when a scanning apparatus having a different function or a scanning apparatus developed by any manufacturer is connected to the host computer 101, the general-purpose scan software 202 allows the user to designate a scan function that is supported by the general-purpose scan software 202 and can be used in the connected scanning apparatus. However, since the general-purpose scan software 202 does not support a manufacturer's unique function, the general-purpose scan software 202 cannot allow the user to designate the manufacturer's unique scan function that can be used in the scanning apparatus connected to the host computer 101. The manufacturer's unique scan function is, for example, a light amount control function.

The light amount control function is a function of controlling a light amount when the scanning apparatus executes a scanning process, and enables to scan a document darkly or to scan a document brightly. For example, when a document is scanned darkly, the image data in a state where correction traces on the document by correction liquid or correction tape are visually recognizable can be obtained. Further, when a document is scanned brightly, image data that puts the correction traces out of sight can be obtained. The light amount control function controls the light amount based on a control level set by the user.

Next, a software configuration for the host computer 101 including the expansion application 204 to instruct the scanning apparatus 102 to execute the scanning process will be described.

FIG. 2B illustrates the software configuration for the host computer 101 with the expansion application 204 to instruct the scanning apparatus 102 to execute the scanning process. Note that the configurations and processes in FIG. 2B not particularly mentioned below are the same as those in FIG. 2A.

As shown in FIG. 2B, the host computer 101 includes the expansion application 204 as software for instructing the scanning apparatus 102 to execute the scanning process in addition to the scan application 201 and the general-purpose scan software 202 described above. The processes by these software components are achieved by the CPU 111 executing programs stored in the external storage device 114.

The expansion application 204 is software that supports the general-purpose scan software 202 and is not included in the OS of the host computer 101 in advance (not packaged). Therefore, the user needs to operate the host computer 101 to download the expansion application 204 from the server via the Internet and install the expansion application 204. Alternatively, the expansion application 204 may be automatically installed in response to the connection of the scanning apparatus 102 to the host computer 101. Specifically, when the scanning apparatus 102 is connected to the host computer 101, the OS of the host computer 101 obtains device identification information from the scanning apparatus 102. The OS of the host computer 101 may download the expansion application 204 corresponding to the obtained device identification information from a server via the Internet and install the expansion application 204. That is, the general-purpose scan software 202 and the expansion application 204 are held in the host computer 101 as separate files.

Note that the general-purpose scan software 202 and the expansion application 204 may be updated and upgraded, but the update processes are also performed at different timings. A timing at which the general-purpose scan software 202 is obtained by the host computer 101 is different from a timing at which the expansion application 204 is obtained. Further, a trigger for the host computer 101 to obtain the general-purpose scan software 202 is also different from a trigger for the host computer 101 to obtain the expansion application 204. When the expansion application 204 is installed in the host computer 101, the OS of the host computer 101 associates the expansion application 204 with the general-purpose scan software 202 and the scanning apparatus 102.

The expansion application 204 includes a scan-setting-screen expansion unit 205, a scan function expansion unit 206, an image data editing unit 207, and a notification unit 209. The expansion application 204 includes shared information 208 that can be accessed in common by the units. Specifically, the shared information 208 is a file stored in the external storage device 114 or information stored in the RAM 113. The expansion application 204 writes and reads information to and from the shared information 208 by using an API (Application Program Interface) provided by the OS of the host computer 101.

Note that the expansion application 204 may end the operation every time a process of each unit is finished. In this case, the OS of the host computer 101 activates the expansion application 204 each time a request to use each unit is received.

Further, the expansion application 204 may cancel a job in a process of each unit. If a job is canceled, the OS of the host computer 101 deletes the job in processing.

Upon receiving a scan request from the user, the scan application 201 issues a scan instruction to the OS of the host computer 101. In the configuration in FIG. 2B, the scan application 201 can display the scan setting screen as with the configuration in FIG. 2A. In the configuration in FIG. 2B, the advanced setting screen provided by the expansion application 204 is displayed. Specifically, the advanced setting screen provided by the scan-setting-screen expansion unit 205 of the expansion application 204 is displayed. The scan-setting-screen expansion unit 205 stores set values set by the user on the advanced setting screen in the shared information 208.

The image data editing unit 207 edits image data obtained from the scanning apparatus 102. The image data editing unit 207 obtains the set values set on the advanced setting screen from the shared information 208 and edits the image data according to the set values. The expansion application 204 may be configured to obtain image data obtained by the general-purpose scan software 202 and edit the image data according to the set values. In the configuration in FIG. 2B, the user may not set the light amount control. In such a case, the general-purpose scan software 202 may issue a scan instruction to the scanning apparatus 102 without passing through the expansion application 204 as with the configuration in FIG. 2A.

The scan function expansion unit 206 can edit the scan function information 203 generated by the general-purpose scan software 202 or the OS of the host computer 101. Thus, the scan function expansion unit 206 can add a function provided by the expansion application 204 to the scan function information 203. The scan function expansion unit 206 can add a scan function that is supported by the scanning apparatus 102 but is not supported by the general-purpose scan software 202, and can add an exclusive relationship between set values of the scan function. A scan function that is supported by the scanning apparatus 102 but is not supported by the general-purpose scan software 202 is, for example, the light amount control function. The OS of the host computer 101 activates the scan function expansion unit 206 when the expansion application 204 is first associated with the scanning apparatus 102 and the general-purpose scan software 202. Further, the OS of the host computer 101 may activate the scan function expansion unit 206 at another timing, such as when the OS of the host computer 101 is activated.

The notification unit 209 can display a notification to the user in response to occurrence of an error in the scanning apparatus 102. For example, when a reading jam error occurs in the scanning apparatus 102, the general-purpose scanning software 202 detects the reading jam error. The OS of the host computer 101 displays a message on the display unit 119 using a notification function called a toast notification, which is a function of the OS. When the user presses the toast notification, the notification unit 209 of the expansion application 204 is called by the OS of the host computer 101, and the notification unit 209 displays a UI (user interface) screen. On the UI screen displayed by the notification unit 209, for example, detailed information about the reading jam error and a jam handling method are displayed.

The configuration of the expansion application 204 is not limited to the configuration including all of the above-described functions (units), and may include a part of the functions or may include other functions. The expansion application 204 may also be simply referred to as scan software. As described above, the expansion application 204 has at least one of the following four functions. The first is a function of displaying a setting screen (the scan-setting-screen expansion unit 205). The second is a function of editing the image data according to the advanced setting (the image data editing unit 207). The third is a function of expanding a function that can be designated by the user (the scan function expansion unit 206). The fourth is a function of displaying a screen in response to occurrence of an error in the scanning apparatus 102 (the notification unit 209).

Next, examples of the scan setting screen and the advanced setting screen displayed on the display unit 119 of the host computer 101 will be described with reference to FIGS. 3A to 3D.

FIG. 3A shows an example of the scan setting screen 300 displayed by the scan application 201 in FIG. 2A. As shown in FIG. 3A, the scan setting screen 300 includes a control 301, a scan button 302, a cancel button 303, and an advanced setting button 304.

The control 301 includes an object to urge the user to designate a scanning apparatus to be used for scanning a document. The scan button 302 is used for scanning start instruction. The cancel button 303 is used for scanning cancel instruction. The advanced setting button 304 is used for an instruction to display the advanced setting screen on the display unit 119. In the present embodiment, the configuration of the advanced setting screen displayed on the display unit 119 depends on whether the host computer 101 includes the expansion application 204.

For example, the display unit 119 of the host computer 101 that does not include the expansion application 204 (see FIG. 2A) displays an advanced setting screen 305a in FIG. 3B. The advanced setting screen 305a is displayed on the display unit 119 by the general-purpose scan software 202 when the user presses the advanced setting button 304. The advanced setting screen 305a includes a control 306a and a setting end button 307a. A reading position can be set in the control 306a, and an “original platen” is set as an example in FIG. 3B. The setting end button 307a is used to end the setting on the advanced setting screen 305a. When the user presses the setting end button 307a, the screen on the display unit 119 returns to the scan setting screen 300.

On the other hand, the display unit 119 of the host computer 101 that includes the expansion application 204 (see FIG. 2B) displays an advanced setting screen 305b in FIG. 3C. The advanced setting screen 305b is displayed on the display unit 119 by the scan-setting-screen expansion unit 205 when the user presses the advanced setting button 304. Although a configuration in which the scan-setting-screen expansion unit 205 causes the display unit 119 to display the advanced setting screen 305b is described in the present embodiment, this is not limiting. For example, the scan-setting-screen expansion unit 205 may be configured to only generate data for displaying the advanced setting screen 305b. In this case, the scan-setting-screen expansion unit 205 transmits the generated display data to the scan application 201 via the general-purpose scan software 202. The scan application 201 causes the display unit 119 to display the advanced setting screen 305b using the obtained display data.

The advanced setting screen 305b includes a control 308b and a list 309b in addition to a control 306b having the same function as the control 306a described above and a setting end button 307b having the same function as the setting end button 307a described above. The control 308b is button for setting the light amount control of the reading unit 195. In FIG. 3C, a level “−2” is selected as an example. The list 309b indicates control levels selectable by the user and is displayed when the user presses the control 308b. The list 309b includes the control levels “−1”, “0”, “1”, and “2” in addition to the level “−2” that is currently selected. When the user selects one control level from the list 309b, the host computer 101 can generate a scan instruction command (described later) including the selected control level. As described above, in the present embodiment, a configuration in which the control level can be selected in a range from the level “−2” to the level “2” will be described as an example. The level “−2” indicates the darkest light amount, the level “−1” indicates the second darkest light amount, the level “0” indicates a default light amount, the level “1” indicates the second brightest light amount, and the level “2” indicates the brightest light amount.

Note that a configuration other than the above-described configuration may be used for setting the light amount. For example, the control level may be set in a range wider than the above range or the control level may be set in a range narrower than the above range. Further, the control levels may be defined such that a negative value indicates a bright light amount and a positive value indicates a dark light amount. Further, the control levels may increase from “0” as a starting point to positive values, that is, negative values may not be used. Further, it may be configured that the user sets a percentage (a numerical value indicating a ratio) of the light amount to a predetermined light amount (default) set in advance as 100% or the user sets a numerical value indicating the light amount.

Here, the reason why the setting items are different between the advanced setting screen 305a and the advanced setting screen 305b will be described.

The advanced setting screen 305a displayed on the display unit 119 of the host computer 101 that does not include the expansion application 204 is generated with reference to the scan capability determined on the basis of the scan function information 203. The scan function information 203 includes information about the scan functions supported by the general-purpose scan software 202 as described above, but the general-purpose scan software 202 does not support the light amount control function, and the scan function information 203 does not include the information about the light amount control function. Thus, the advanced setting screen 305a does not include the control 308b and the list 309b for setting the light amount control function.

On the other hand, the advanced setting screen 305b displayed on the display unit 119 of the host computer 101 having the expansion application 204 is generated by referring to the scan capability generated on the basis of the scan function information 203 edited by the scan function expansion unit 206. The scan function information 203 includes the information about the light amount control function added by the scan function expansion unit 206. Thus, the advanced setting screen 305b includes the control 308b and the list 309b for setting the light amount control function. The advanced setting screen 305b may further include a setting item of a scan function unique to a manufacturer other than the light amount control function.

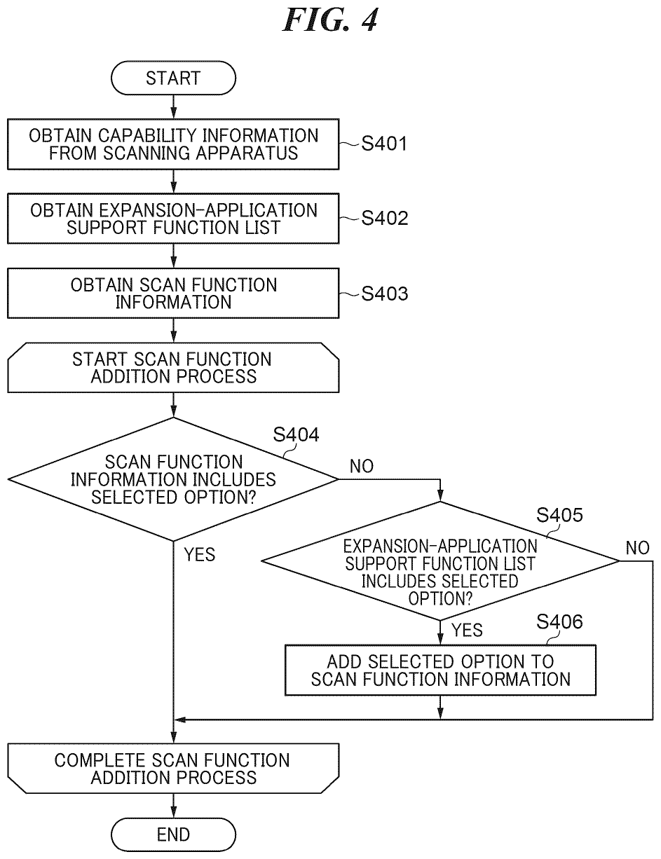

Next, an editing control process in which the scan function expansion unit 206 edits the scan function information 203 will be described. FIG. 4 is a flowchart illustrating procedures of the editing control process executed by the scan function expansion unit 206 in FIG. 2B. The editing control process in FIG. 4 is achieved by the CPU 111 executing a program of the expansion application 204 read from the external storage device 114 to the RAM 113. The editing control process of FIG. 4 is executed, for example, when the expansion application 204 is activated.

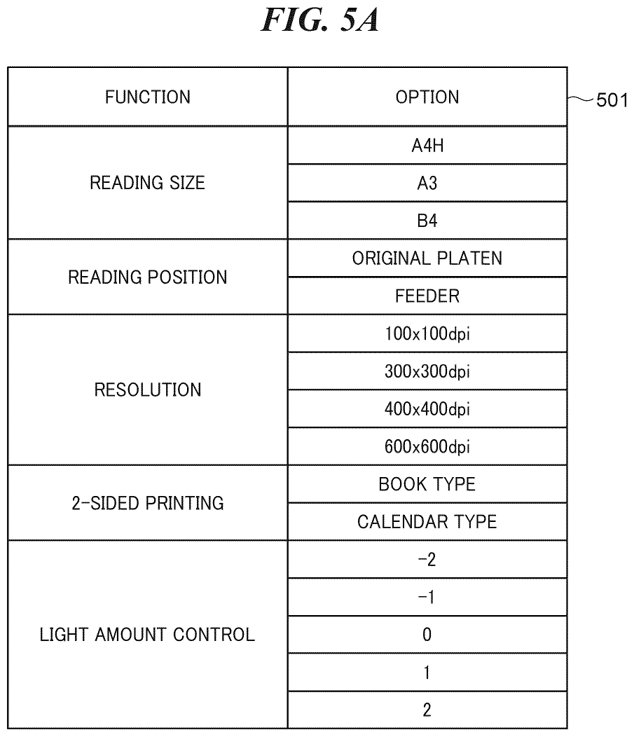

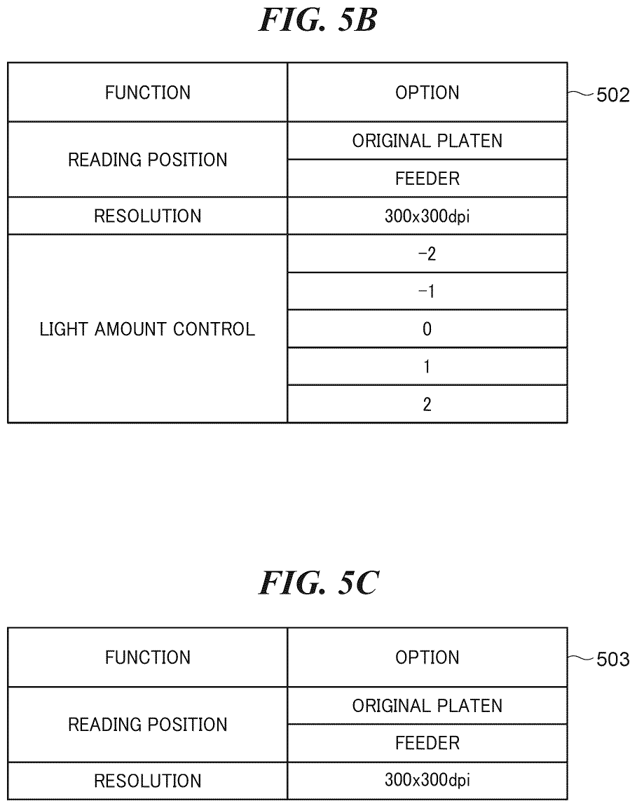

In FIG. 4, the scan function expansion unit 206 first obtains capability information from the scanning device 102 connected to the host computer 101 in S401. The capability information includes attribute information indicating functions that can be designated by the scanning apparatus 102, and set values associated with the attribute information. A table 501 in FIG. 5A is an example of the capability information obtained from the scanning apparatus 102. As shown in the table 501, the information about functions such as a reading size and a light amount control, and information about options that are set values settable for the respective functions can be obtained from the scanning apparatus 102.

Next, the scan function expansion unit 206 obtains a list of scan functions supported by the expansion application 204 (hereinafter referred to as an “expansion-application support function list”) in S402. The expansion-application support function list is registered in the shared information 208 and describes all scan functions supported by the expansion application 204 and set values thereof. A table 502 in FIG. 5B is an example of the expansion-application support function list. The expansion-application support function list may be updated by updating the expansion application 204.

Then, the scan function expansion unit 206 obtains the scan function information 203 generated by the general-purpose scan software 202 from the OS in S403. A table 503 in FIG. 5C is an example of the scan function information 203 generated by the general-purpose scan software 202. The general-purpose scan software 202 generates the scan function information 203 on the basis of the capability information (see the table 501 in FIG. 5A) obtained by the general-purpose scan software 202 from the scanning apparatus 102. The scan function information 203 generated by the general-purpose scan software 202 records only the scan functions supported by the general-purpose scan software 202 among the scan functions recorded in the capability information obtained from the scanning apparatus 102. Therefore, the functions recorded in the scan function information 203 are limited. For example, the capability information in FIG. 5A includes the light amount control function, but the general-purpose scan software 202 does not support the light amount control function (see the table 503 in FIG. 5C). Therefore, the information about the light amount control function is not recorded in the scan function information 203. In the present embodiment, the scan function expansion unit 206 adds a function and an option to the scan function information 203, and thus the expansion application 204 can compensate for a lack of function of the general-purpose scan software 202. The scan function expansion unit 206 can also delete unnecessary functions and options from the scan function information 203 generated by the general-purpose scan software 202.

Next, the scan function expansion unit 206 performs a scan function addition process. Specifically, the scan function expansion unit 206 performs S404, S405, and S406. The scan function addition process is repeatedly performed for each option of the functions recorded in the capability information obtained from the scanning apparatus 102 in S401. In the present embodiment, the scan function addition process is repeatedly performed for sixteen items from an option “A4H” of the reading size to an option “2” of the light amount control in the capability information in FIG. 5A. The scan function expansion unit 206 selects one of the options for each function in the capability information obtained in S401.

The scan function expansion unit 206 first determines whether the scan function information 203 generated by the general-purpose scan software 202 includes the selected option in S404. For example, when the option “original platen” of the reading position is selected from the capability information in FIG. 5A, the option “original platen” is included in the scan function information 203 in FIG. 5C. In such a case, it is determined in S404 that the scan function information 203 generated by the general-purpose scan software 202 includes the selected option. On the other hand, when the option “A4H” of the reading size is selected from the capability information in FIG. 5A, the option “A4H” is not included in the scan function information 203 in FIG. 5C. In such a case, it is determined in S404 that the scan function information 203 generated by the general-purpose scan software 202 does not include the selected option.

When it is determined in S404 that the scan function information 203 generated by the general-purpose scan software 202 includes the selected option, the scan function expansion unit 206 selects the next option and the editing control process returns to S404. Note that, when the option that is subjected to the determination in S404 is the last option in the capability information obtained in S401 (for example, it is the option “2” of the light amount control in the capability information in FIG. 5A), the scan function addition process ends and the editing control process ends.

When it is determined in S404 that the scan function information 203 generated by the general-purpose scan software 202 does not include the selected option, the editing control process proceeds to S405.

The scan function expansion unit 206 determines in S405 whether the expansion-application support function list obtained in S402 includes the selected option. For example, when an option “100×100 dpi” of resolution is selected from the capability information in FIG. 5A, the option “100×100 dpi” is not included in the expansion-application support function list in FIG. 5B. In such a case, it is determined in S405 that the expansion-application support function list does not include the selected option, the scan function expansion unit 206 selects the next option, and the editing control process returns to S404. Note that, when the option that is subjected to the determination in S405 is the last option in the capability information obtained in S401, the scan function addition process ends and the editing control process ends.

On the other hand, when the option “−2” of the light amount control is selected from the capability information in FIG. 5A, the option “−2” is included in the expansion-application support function list in FIG. 5B. In such a case, it is determined in S405 that the expansion-application support function list includes the selected option, and the editing control process proceeds to S406.

The scan function expansion unit 206 adds the selected option to the scan function information 203 in S406. The scan function expansion unit 206 then selects the next option and the edit control process returns to S404. Note that, when the option added to the scan function information 203 in S406 is the last option in the capability information obtained in S401, the scan function addition process ends and the editing control processing ends.

As described above, the scan function expansion unit 206 adds, to the scan function information 203, an option of a scan function that is not supported by the general-purpose scan software 202 and is supported by the scanning apparatus 102 and the expansion application 204. The scan capability is generated on the basis of the scan function information 203 edited by the above-described editing control process in FIG. 4. Further, the scan-setting-screen expansion unit 205 generates display data for the advanced setting screen based on the generated scan capability. This enables to display the advanced setting screen in FIG. 3C on which the scan function supported by the scanning apparatus 102 and the expansion application 204 but is not supported by the general-purpose scan software 202 can be set.

Next, a scan control process from accepting a scan setting to displaying image data generated by scanning a document by the scanning apparatus 102 in the communication system in FIG. 1 will be described.

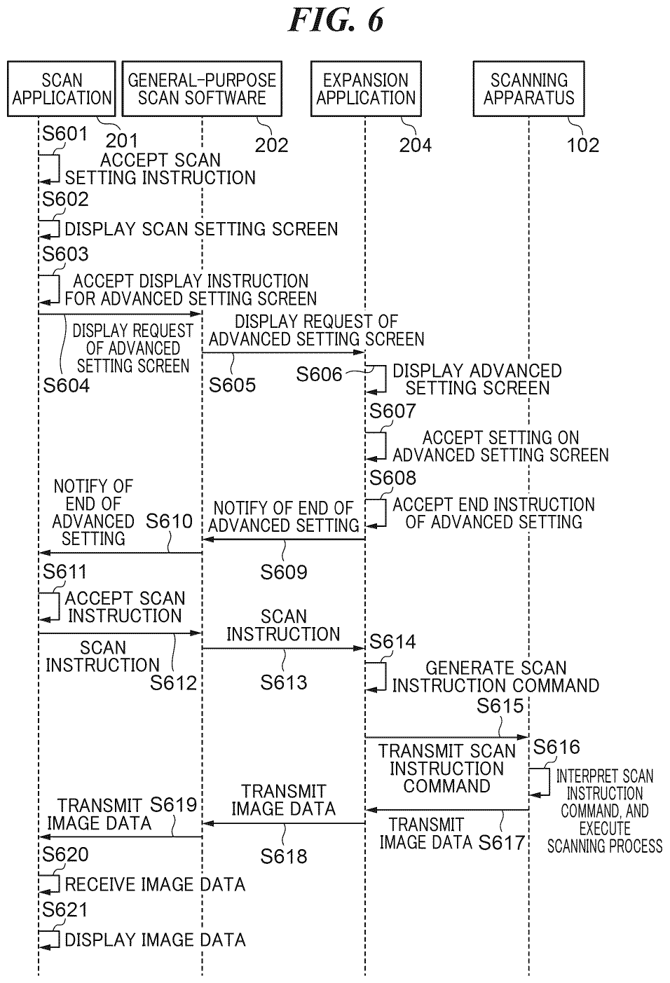

FIG. 6 is a sequence chart illustrating procedures of the scan control process performed in the communication system in FIG. 1. The process in FIG. 6 executed by the host computer 101 is achieved by the CPU 111 reading programs of the scan application 201, the general-purpose scan software 202, and the expansion application 204 from the external storage device 114 to the RAM 113 and executing the programs. The process in FIG. 6 executed by the scanning apparatus 102 is achieved by the CPU 191 of the scanning apparatus 102 reading the programs stored in the ROM 192 or the external storage device 199 to the RAM 193 and executing the programs. In the present embodiment, as shown in FIG. 2B described above, the scan control process in which the host computer 101 includes the expansion application 204 will be described. In the scan control process in FIG. 6, the editing control process in FIG. 4 shall have been executed. The editing control process adds, to the scan function information 203, an option of a scan function (for example, the light amount control function) that is not supported by the general-purpose scan software 202 and is supported by the scanning apparatus 102 and the expansion application 204.

In FIG. 6, the scan application 201 first accepts a scan setting instruction by the user in S601. The scan setting instruction is an instruction for performing the scan setting used in the scan process to be executed by the scanning apparatus 102 connected to the host computer 101. The user can issue the scan setting instruction to the scan application 201 by operating the pointing device 117 or the keyboard 118.

Next, the scan application 201 causes the display unit 119 to display the scan setting screen 300 in accordance with the received scan setting instruction in S602.

Next, the scan application 201 accepts a display instruction for the advanced setting screen in S603. The user can issue the display instruction for the advanced setting screen by operating the pointing device 117 or the keyboard 118 to select the detailed setting button 304 on the scan setting screen 300.

Next, the scan application 201 issues in S604 a display request of the advanced setting screen to the general-purpose scan software 202 in accordance with the received display instruction for the advanced setting screen.

Next, the general-purpose scan software 202 issues in S605 a display request of the advanced setting screen to the expansion application 204 in accordance with the received display request. As shown in FIG. 2A described above, when the host computer 101 does not include the expansion application 204, the general-purpose scan software 202 causes the display unit 119 to display the advanced setting screen 305a.

Then, the scan-setting-screen expansion unit 205 of the expansion application 204 causes in S606 the display unit 119 to display the advanced setting screen 305b. Specifically, the scan-setting-screen expansion unit 205 causes the display unit 119 to display the advanced setting screen 305b by referring to the scan capability generated on the basis of the scan function information 203 to which the option of the function such as the light amount control function is added in the above-described editing control process in FIG. 4. As described above, the advanced setting screen 305b includes the control 308b and the list 309b for setting the light amount control of the reading unit 195. In the present embodiment, since the resolution supported by the expansion application 204 is only one type of “300×300 dpi” as shown in FIG. 5B, it is unnecessary to cause the user to select the resolution, and this setting item is not displayed in the advanced setting screen 305b. Note that this configuration is an example, and the advanced setting screen 305b may include a resolution-setting item in which “300×300 dpi” is selected.

Then, the scan-setting-screen expansion unit 205 accepts in S607 the setting by the user on the advanced setting screen 305b. The advanced setting screen 305b in FIG. 3C shows an example in which the user sets the “original platen” as the reading position and the “−2” as the control level of the light amount control. The CPU 111 stores the values set on the advanced setting screen 305b in the RAM 113.

Next, the scan-setting-screen expansion unit 205 accepts in S608 an end instruction of the advanced setting from the user. The user can issue the end instruction of the advanced setting by selecting the setting end button 307b by operating the pointing device 117 or the keyboard 118. Upon accepting the end instruction of the advanced setting, the scan-setting-screen expansion unit 205 writes the values set on the advanced setting screen 305b to the scan setting information. The scan-setting-screen expansion unit 205 may also write the set value of the item that is not selected by the user, such as the resolution, in the scan setting information together with the other set values. The scan setting information is held in the RAM 113 or the like.

Then, the expansion application 204 notifies in S609 the general-purpose scan software 202 of the end of the advanced setting.

Next, the general-purpose scan software 202 notifies in S610 the scan application 201 of the end of the advanced setting.

Upon receiving the notification, the scan application 201 switches the screen on the display unit 119 to the scan setting screen 300. The scan application 201 accepts a scan instruction from the user in S611. The user can issue the scan instruction by selecting the scan button 302 by operating the pointing device 117 or the keyboard 118.

Next, the scan application 201 issues a scan instruction to the general-purpose scan software 202 in S612.

Then, the general-purpose scan software 202 issues a scan instruction to the expansion application 204 in S613.

Next, the expansion application 204 generates in S614 a scan instruction command based on the scan setting information written in S608. If the set value of the item that is not selected by the user is not written in the scan setting information in S608, the expansion application 204 may add the set value to the scan instruction command when generating the scan instruction command in S614. Alternatively, the scanning apparatus 102 may be operated with default set values without adding the additional information.

Then, the expansion application 204 transmits (outputs) the scan instruction command to the scanning apparatus 102 in S615.

Next, the scanning apparatus 102 interprets the received scan instruction command and executes the scanning process in the S616. In S616, an image process corresponding to the scan instruction command is applied to image data obtained by scanning a document. In the present embodiment, when the light amount control is set on the advanced setting screen 305b, the scanning process is performed with the light amount corresponding to the control level set in the control 308b. In this way, the image data scanned with the light amount intended by the user is generated.

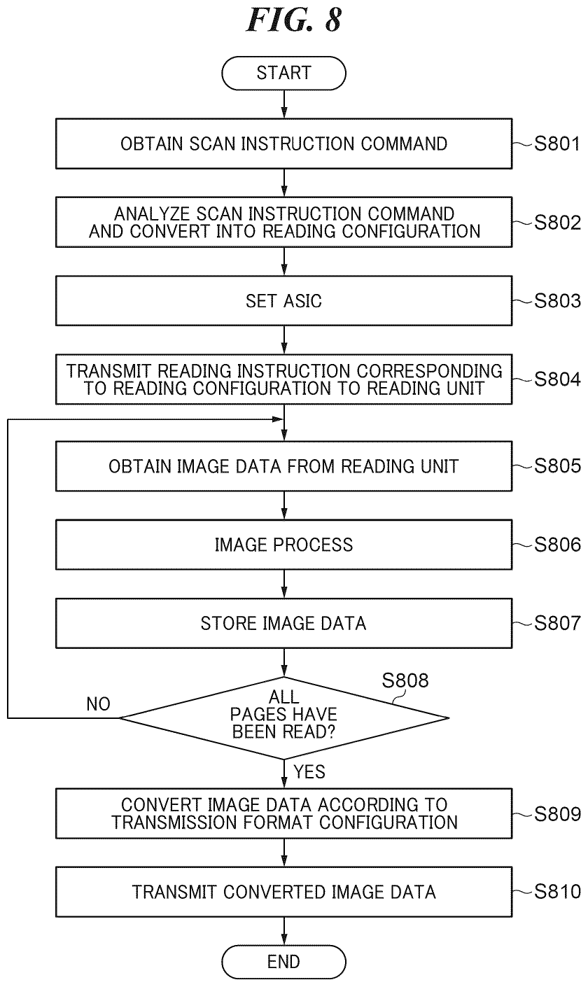

Then, the scanning apparatus 102 transmits the generated image data to the expansion application 204 in S617. The above-described processes in S616 and S617 executed by the scanning apparatus 102 will be described later with reference to FIG. 8.

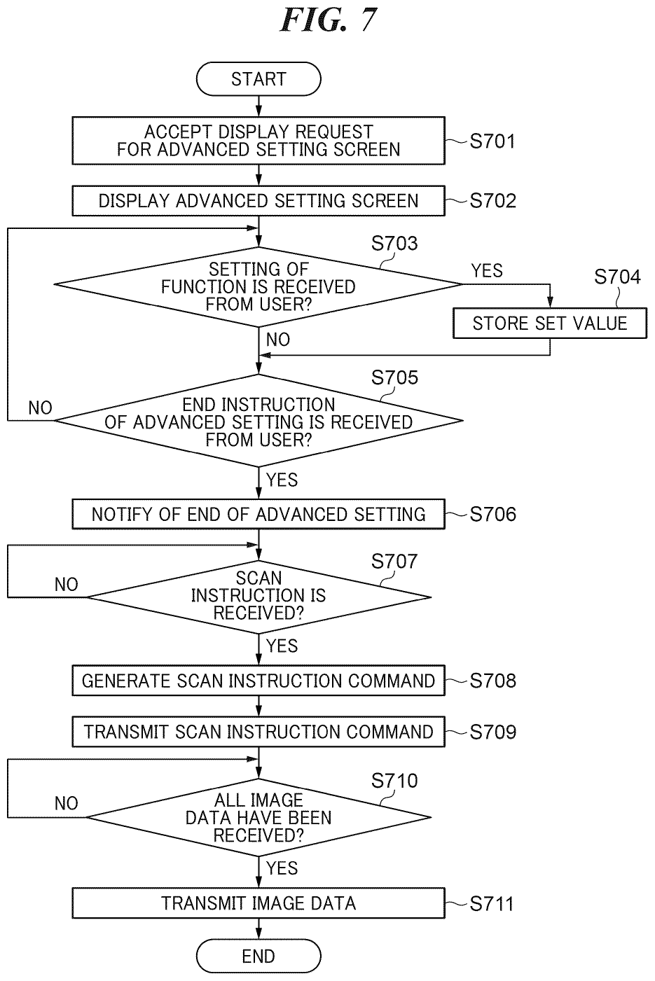

Then, the expansion application 204 transmits the received image data to the general-purpose scan software 202 in S618. The above-described processes in S606, S607, S608, S609, S614, S615, and S618 executed by the expansion application 204 will be described later with reference to FIG. 7.

Then, the general-purpose scan software 202 transmits the received image data to the scan application 201 in S619.

Then, the scan application 201 receives the image data in S620. Next, the scan application 201 displays the received image data on the display unit 119 in S621. The image data obtained by the scanning process with the light amount corresponding to the control level set in the control 308b is displayed on the display unit 119. For example, when the control level “−2” is set in the control 308b, image data in a state where correction traces on the document due to correction liquid or correction tape are visually recognizable is displayed on the display unit 119. When the control level “2” is set in the control 308b, image data that puts the correction traces out of sight is displayed on the display unit 119. Thereafter, the present process ends.

Although the configuration in which the scan application 201 displays the image data received from the scanning apparatus 102 on the display unit 119 in S621 has been described in the present embodiment, this is not limiting. For example, the expansion application 204 may display the image data on the display unit 119.

In the present embodiment, the advanced setting screen 305b may further include a display area 310b for displaying a document read result as a preview image and a preview button 311b used to instruct display of a preview image in the display area 310b as shown in FIG. 3D. When the user operates the preview button 311b in the state shown in FIG. 3D, a preview image is displayed in the display area 310b. Note that the preview image may be a low-resolution image. Further, the light amount in scanning can be changed by operating the control 308b in a state where a preview image is displayed. This updates the preview image in the display area 310b to an image to which the changed control level is reflected. The preview image at this time may be an image based on a scanned image obtained by scanning the document again, or may be an image obtained by processing an already obtained scanned image by the expansion application 204. When an intended image is displayed in the display area 310b as the preview image, the user operates the setting end button 307b. According to such a configuration, the user can instruct to execute the main scan after confirming the degree of visibility of the correction traces in the pre-scan.

Although the configuration in which the scanning apparatus 102 transmits the generated image data to the host computer 101 has been described in the present embodiment, this is not limiting. For example, the scanning apparatus 102 may transmit the generated image data to a designated transmission destination by FAX or e-mail. The transmission destination may be stored in the scanning apparatus 102, and the process may be completed by the scanning apparatus 102 after issuing the scan instruction. Alternatively, the information stored in an address book of a personal computer, a smartphone, or the like may be obtained. Further, a destination input screen/field may be displayed to urge the user to set the transmission destination.

Next, a scan instruction command generation process executed by the expansion application 204 will be described. The scan instruction command generation process includes the processes in S606, S607, S608, S609, S614, S615, and S618 described above.

FIG. 7 is a flowchart illustrating procedures of the scan instruction command generation process executed by the expansion application 204 in FIG. 2B. The scan instruction command generation process in FIG. 7 is achieved by the CPU 111 executing the program of the expansion application 204 read from the external storage device 114 to the RAM 113.

In FIG. 7, the expansion application 204 first accepts the display request of the advanced setting screen from the general-purpose scan software 202 in S701. Next, the scan-setting-screen expansion unit 205 of the expansion application 204 causes in S702 the display unit 119 to display the advanced setting screen 305b in accordance with the received display request (for example, see S606 described above).

Then, the scan-setting-screen expansion unit 205 determines in S703 whether setting of a function is received from the user on the advanced setting screen 305b.

When it is determined in S703 that the setting of the function is received from the user on the advanced setting screen 305b (for example, see S607 described above), the expansion application 204 stores in S704 the set value set on the advanced setting screen 305b in the RAM 113. Thereafter, the process proceeds to S705.

When it is determined in S703 that the setting of the function is not received from the user on the advanced setting screen 305b, the process also proceeds to S705.

In S705, the scan-setting-screen expansion unit 205 determines whether the end instruction of the advanced setting is received from the user.

When it is determined in S705 that the end instruction of the advanced setting is not received from the user, the process returns to S703. When it is determined in S705 that the end instruction of the advanced setting is received from the user (for example, see S608 described above), the process proceeds to S706. Note that if YES is determined in both S703 and S705, the scan-setting-screen expansion unit 205 writes the set value set on the advanced setting screen 305b to the scan setting information. Thereafter, the process proceeds to S706.

In S706, the expansion application 204 notifies the general-purpose scan software 202 of the end of the advanced setting.

Next, the expansion application 204 determines in S707 whether the scan instruction is received from the general-purpose scan software 202. The expansion application 204 waits until the scan instruction is received. When the scan instruction is received (YES in S707), the expansion application 204 generates the scan instruction command in S708 based on the scan setting information written in S705 (for example, see S614 described above). The scan instruction command is generated by a method of expanding a function of a command conforming to a standard protocol. As a method of extending a function of a command conforming to a standard protocol, for example, there are a method of recording a set state of the light amount control function as a dedicated command in an expansion area of the command conforming to the standard protocol and a method of adding a command conforming to a manufacturer's original standard to the end of the command conforming to the standard protocol. The expansion application 204 may generate the scan instruction command by converting a command conforming to a standard protocol into a command conforming to an original command system. When the expansion application 204 issues an instruction, the instruction and communication may be performed using a manufacture's original protocol regardless of the standard protocol.

Next, the expansion application 204 transmits (outputs) in S709 the scan instruction command to the scanning apparatus 102 (for example, see S615 described above).

Then, the expansion application 204 determines in S710 whether all image data have been received from the scanning apparatus 102. The expansion application 204 waits until all the image data are received. And when all the image data have been received (YES in S710), the expansion application 204 transmits the received image data to the general-purpose scan software 202 in S711 (for example, see S618 described above). Thereafter, the present process ends.

Next, a control process executed by the scanning apparatus 102 will be described. The control process includes S616 and S617 described above.

FIG. 8 is a flowchart illustrating procedures of the control process executed by the scanning apparatus 102 in FIG. 1. The control process in FIG. 8 is achieved by the CPU 191 executing a program stored in the ROM 192.

In FIG. 8, the CPU 191 first obtains the scan instruction command transmitted from the expansion application 204 in S801.

Next, the CPU 191 analyzes in S802 the scan instruction command obtained in S801 and converts the scan instruction command into a reading set state used by the scanning apparatus 102 for the scanning process. In the present embodiment, the CPU 191 shall convert the command into the reading set state in which the reading position is “original platen”, the light amount control level is “−2”, and the resolution is “300×300 dpi”, for example. Next, the CPU 191 sets in S803 an ASIC of the image processor 190 used for execution of the scanning process based on the reading set state converted in S802.

Then, the CPU191 transmits a reading instruction corresponding to the reading set state to the reading unit 195 in S804. In the present embodiment, for example, the CPU 191 transmits the reading instruction in which the reading position is set to “original platen” and the light amount control level is set to “−2” to the reading unit 195. Upon receiving the instruction, the reading unit 195 performs a reading operation with the light amount corresponding to the control level “−2”.

Next, the CPU 191 obtains in S805 the image data from the reading unit 195. Next, the CPU 191 controls in S806 the image processor 190 to perform the image process on the obtained image data. In S806, the image process for converting the resolution to “300×300 dpi”, for example, is performed on the obtained image data. Note that, when the reading unit 195 can read at “300×300 dpi” and the reading unit 195 obtains the image data at “300×300 dpi”, the image process for converting the resolution to “300×300 dpi” may not be executed in S806.

Then, the CPU 191 stores the image data to the external storage device 199 in S807. Next, the CPU 191 determines in S808 whether all pages have been read.

When it is determined in S808 that any page has not been read, the process returns to S805.

When it is determined in S808 that all pages have been read, the process proceeds to S809. The CPU 191 controls in S809 the image processor 190 to convert the image data stored in S807 into a designated transmission format. In the present embodiment, the transmission format is not included in the scan instruction command obtained in S801, and the image data is converted in S809 into the JPEG format, which is a default set state of the scanning apparatus 102. However, the transmission format of the conversion destination is not limited to the JPEG format. The transmission format of the conversion destination may be a format other than the JPEG format as long as the format is supported by the host computer 101. Then, the CPU 191 controls in S810 the NETIF 197 to transmit the image data converted in S809 to the expansion application 204. Thereafter, the present process ends.

According to the embodiment, the extended application 204 causes the display unit 119 to display the advanced setting screen 305b for receiving the setting of the light amount during the scanning process. The extended application 204 outputs the scan instruction command for causing the scanning apparatus 102 to execute the scanning process with the light amount corresponding to the control level set on the advanced setting screen 305b. This allows the user to use the light amount control function.

In the above-described embodiment, the user selects one control level from among the plurality of control levels corresponding to different light amounts on the advanced setting screen 305b. This allows the user to select the light amount suitable for the purpose of use from among the plurality of choices in the setting of the light amount control.

In addition, in the case where the user sets a percentage of the light amount to the predetermined light amount set in advance on the advanced setting screen, the user can intuitively set the light amount suitable for a purpose of use in setting of the light amount control.

In addition, in the case where the user sets the numerical value indicating the light amount on the advanced setting screen, the user can perform fine adjustment of the light amount in the scanning process.

In the above-described embodiment, the expansion application 204 generates the scan instruction command for causing the scanning apparatus 102 to execute the scanning process with the light amount corresponding to the control level set on the advanced setting screen 305b. This allows the scanning apparatus 102 to execute the scanning process with the light amount corresponding to the control level set on the advanced setting screen 305b.

In the above-described embodiment, the scan instruction command can be generated by expanding the function of the command conforming to the standard protocol. This allows the scanning apparatus 102 to execute the scanning process with the light amount corresponding to the control level set on the advanced setting screen 305b by using the standard protocol.

In the above-described embodiment, the scan instruction command may be generated by converting a command conforming to a standard protocol into a command system unique to the expansion application 204. This can reflect the set state of the scan function that is not supported by the standard protocol to the scan instruction command.

Although the configuration in which the advanced setting screen 305b is displayed on the display unit 119 of the host computer 101 (for example, see FIG. 2B) including the expansion application 204 has been described in the above-described embodiment, the present invention is not limited thereto. For example, when accepting the display request of the advanced setting screen in S604, the general-purpose scan software 202 may cause the display unit 119 to display the advanced setting screen 305a. After the setting on the advanced setting screen 305a is completed, the general-purpose scan software 202 requests the expansion application 204 to display an additional advanced setting screen. In response to the display request, the expansion application 204 causes the display unit 119 to display, for example, an advanced setting screen (not shown) that does not include the control 306b and includes the setting end button 307b, the control 308b, and the list 309b. Even in such a configuration, the user can use the light amount control function.

Although the general-purpose scan software 202 transmits the scan instruction command to the expansion application 204 in S613 in the above-described embodiment, this is not limiting. For example, the scan application 201 may directly issue a scan instruction to the expansion application 204. Further, a scan instruction control may be displayed on the advanced setting screen 305b so that the user may directly instruct the expansion application 204.

Although the configuration in which the expansion application 204 passes the image data received from the scanning apparatus 102 to the scan application 201 via the general-purpose scan software 202 is described in the above-described embodiment, this is not limiting. For example, the expansion application 204 may directly transfer the image data to the scan application 201 without passing through the general-purpose scan software 202. Alternatively, the scan request may be transferred from the scanning apparatus 102 to the scan application 201. Alternatively, the image data obtained from the scanning apparatus 102 may be stored in the external storage device 114, and only information about a file path indicating a storage destination may be transferred.

Although the configuration in which the transfer is started after determining that all the image data have been received in S710 has been described in the above-described embodiment, this is not limiting. For example, the image data may be transferred at any time.

Next, a communication system, an information processing apparatus, and a control method for the information processing apparatus according to a second embodiment will be described. The second embodiment is basically the same as the first embodiment in configurations and operations, and is different from the first embodiment in that the expansion application 204 edits the scan instruction command generated by the general-purpose scan software 202. Therefore, the descriptions about the same configurations and operations will be omitted, and the different configurations and operations will be described below.

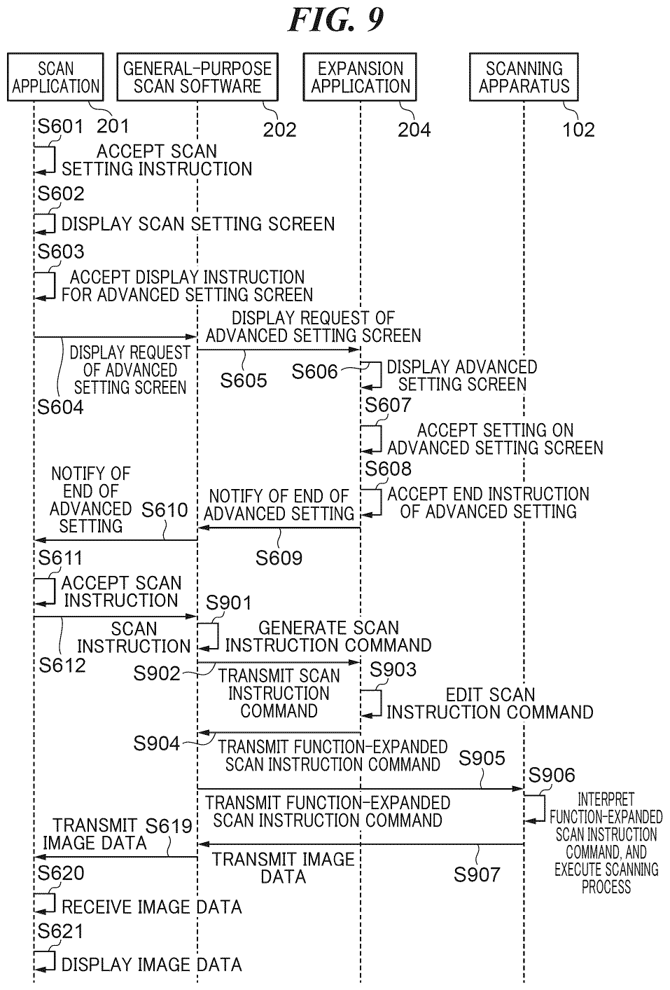

FIG. 9 is a sequence chart illustrating procedures of a scan control process performed by the communication system according to the second embodiment. The scan control process in FIG. 9 is similar to the scan control process in FIG. 6, and the following description will be focused on the differences from the scan control process in FIG. 6. The process by the host computer 101 in FIG. 9 is achieved by the CPU 111 reading programs of the scan application 201, the general-purpose scan software 202, and the expansion application 204 from the external storage device 114 to the RAM 113 and executing the programs. The process in FIG. 9 by the scanning apparatus 102 is achieved by the CPU 191 of the scanning apparatus 102 reading a program stored in the ROM 192 or the external storage device 199 to the RAM 193 and executing the program. The scan control process in FIG. 9 under the configuration in which the host computer 101 includes the expansion application 204 as shown in FIG. 2B will be described. In the scan control process in FIG. 9, the edit control process in FIG. 4 shall have been executed. The editing control process adds, to the scan function information 203, an option of a scan function (for example, the light amount control function) that is not supported by the general-purpose scan software 202 and is supported by the scanning apparatus 102 and the expansion application 204.

In FIG. 9, the process from S601 to S612 described above is performed first. Then, the general-purpose scan software 202 generates a scan instruction command in S901. Note that the scan instruction command generated in S901 does not record a scan function, such as the light amount control function, that is not supported by the general-purpose scan software 202.

Next, the general-purpose scan software 202 transmits the generated scan instruction command to the expansion application 204 in S902.

Then, the expansion application 204 edits the received scan instruction command in S903. Specifically, the expansion application 204 adds an instruction command of the scan function that is not supported by the general-purpose scan software 202 to the received scan instruction command or changes an existing instruction. Here, the scan instruction command generated by the general-purpose scan software 202 in S901 does not include the set state of the light amount control function such as the control level set on the advanced setting screen 305b. Therefore, the set state of the light amount control function is added to the received scan instruction command in S903. Hereinafter, the scan instruction command obtained in S903 is referred to as a function-expanded scan instruction command.

Then, the expansion application 204 transmits the function-expanded scan instruction command to the general-purpose scan software 202 in S904.

The general-purpose scan software 202 transmits the function-expanded scan instruction command to the scanning apparatus 102 in S905. Next, the scanning apparatus 102 interprets the function-expanded scan instruction command and executes the scanning process in S906.

Then, the scanning apparatus 102 transmits the generated image data to the general-purpose scan software 202 in S907. Thereafter, the process from S619 to S621 is performed, and the process ends.

In the second embodiment described above, the expansion application 204 adds the set state of the light amount control function set on the advanced setting screen 305b to the scan instruction command generated by the general-purpose scan software 202. This allows the scanning device 102 to execute the scanning process with the light amount corresponding to the set value set on the advanced setting screen 305b.

Next, a communication system, an information processing apparatus, and a control method for the information processing apparatus according to a third embodiment will be described. The third embodiment is basically the same as the first embodiment in configurations and operations, and is different from the first embodiment in that the standard scan instruction command conforming to the standard protocol is not expanded and an expanded scan instruction command is separately generated. Therefore, the descriptions about the same configurations and operations will be omitted, and the different configurations and operations will be described below.

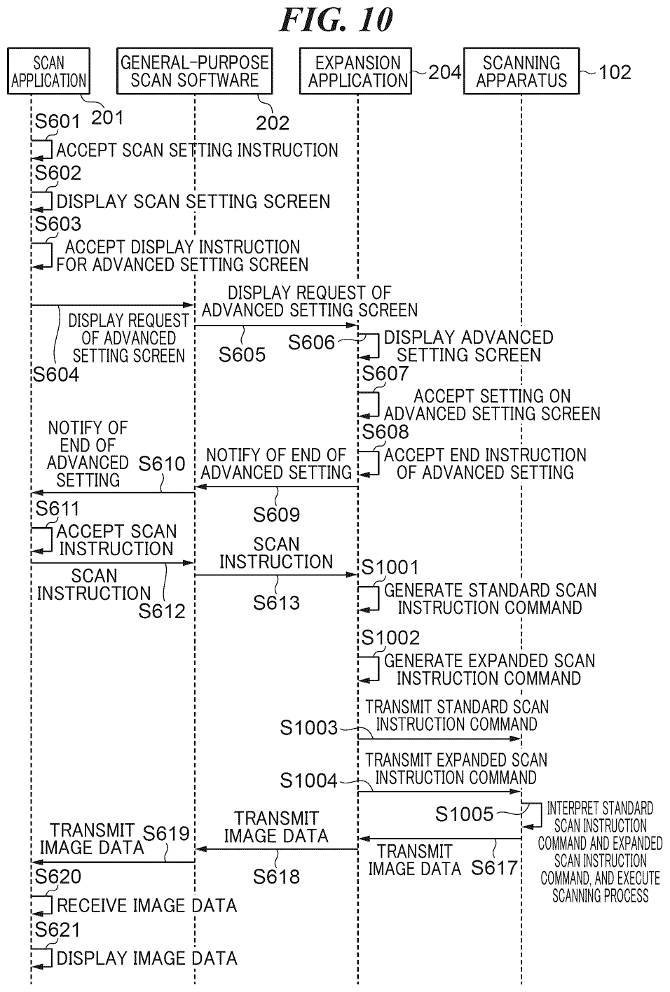

FIG. 10 is a sequence chart illustrating procedures of a scan control process performed by the communication system according to the third embodiment. The scan control process in FIG. 10 is similar to the scan control process in FIG. 6, and the following description will be focused on the differences from the scan control process in FIG. 6. The process by the host computer 101 in FIG. 10 is achieved by the CPU 111 reading programs of the scan application 201, the general-purpose scan software 202, and the expansion application 204 from the external storage device 114 to the RAM 113 and executing the programs. The process by the scanning apparatus 102 in FIG. 10 is achieved by the CPU 191 of the scanning apparatus 102 reading a program stored in the ROM 192 or the external storage device 199 to the RAM 193 and executing the program. The scan control process in FIG. 10 under the configuration in which the host computer 101 includes the expansion application 204 as shown in FIG. 2B will be described. In the scan control process in FIG. 10, the edit control process in FIG. 4 shall have been executed in advance. The editing control process adds, to the scan function information 203, an option of a scan function (for example, the light amount control function) that is not supported by the general-purpose scan software 202 and is supported by the scanning apparatus 102 and the expansion application 204.

In FIG. 10, the process from S601 to S613 described above is performed first. Next, the expansion application 204 generates a standard scan instruction command conforming to the standard protocol in S1001. Note that the standard scan instruction command generated in S1001 does not record a scan function that is not supported by the standard protocol. For example, when the light amount control function is not supported by the standard protocol, the standard scan instruction command does not include the setting of the light amount control function such as the control level set on the advanced setting screen 305b.

Then, the expansion application 204 generates in S1002 an extended scan instruction command to achieve the scan function that is not supported by the standard protocol. The expanded scan instruction command includes, for example, a setting of a scan function that is not supported by the standard protocol and is supported by the expansion application 204. For example, when the light amount control function is not supported by the standard protocol, the expanded scan instruction command includes the setting of light amount control function such as the control level set on the advanced setting screen 305b.

Then, the expansion application 204 transmits the standard scan instruction command to the scanning apparatus 102 in S1003. In addition, the expansion application 204 transmits the expanded scan instruction command to the scanning apparatus 102 in S1004.

Next, the scanning apparatus 102 interprets the received standard scan instruction command and the extended scan instruction command, and executes the scanning process in S1005. Thereafter, the process from S617 to S621 is performed, and the process ends.

Here, a scan instruction command generation process executed by the expansion application 204 in the third embodiment will be described. The scan instruction command generation process includes the processes in S606, S607, S608, S609, S1001, S1002, S1003, S1004, and S618 described above.

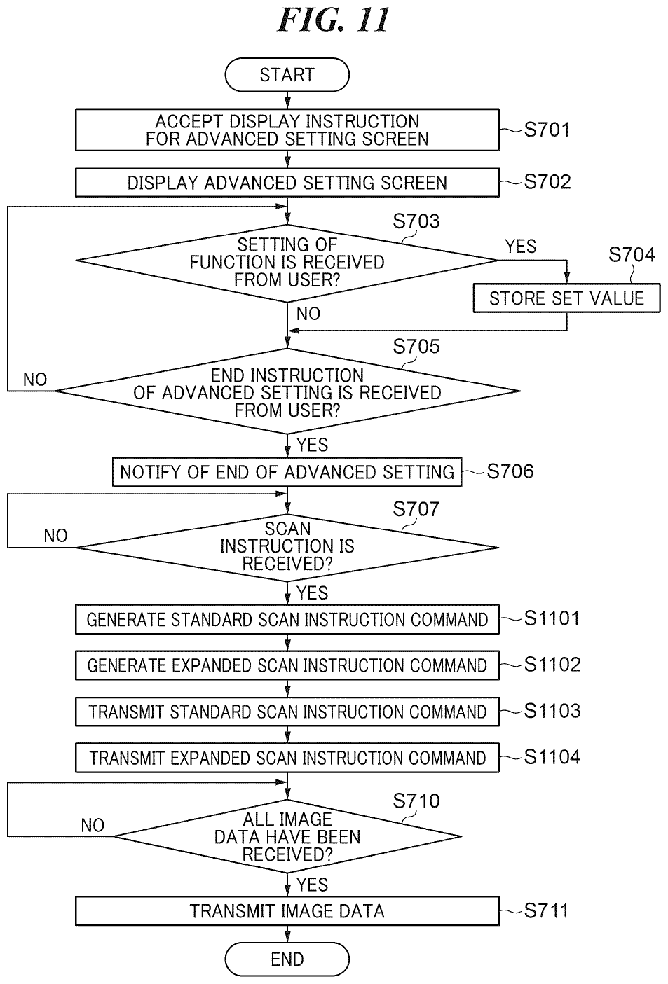

FIG. 11 is a flowchart illustrating procedures of the scan instruction command generation process executed by the expansion application 204 in the third embodiment. The scan instruction command generation process in FIG. 11 is similar to the scan instruction command generation process in FIG. 7, and the following description will be focused on the differences from the scan instruction command generation process in FIG. 7. The scan instruction command generation process in FIG. 9 is also achieved by the CPU 111 executing the program of the expansion application 204 read from the external storage device 114 to the RAM 113 as with the scan instruction command generation process in FIG. 7 described above.

In FIG. 11, the process from S701 to S707 described above is performed first. When the scan instruction is received (YES in S707), the expansion application 204 generates the standard scan instruction command conforming to the standard protocol in S1101 (for example, see S1001 described above). Next, the expansion application 204 generates in S1102 the expanded scan instruction command for achieving the scan function that is not supported by the standard protocol (for example, see S1002 described above). Next, the expansion application 204 transmits in S1103 the standard scan instruction command generated in S1101 to the scanning apparatus 102 (for example, see S1003 described above). Next, the expansion application 204 transmits in S1104, the expanded scan instruction command generated in S1102 to the scanning apparatus 102 (for example, see S1004 described above). Thereafter, the process from S710 to S711 is performed, and the process ends.

In the third embodiment described above, the standard scan instruction command conforming to the standard protocol and the expanded scan instruction command to achieve the scan function that is not supported by the standard protocol are transmitted to the scanning apparatus 102. This allows to reflect the setting of the scan function, which is not supported by the standard protocol, to the scan instruction command.

Next, a communication system, an information processing apparatus, and a control method for the information processing apparatus according to a fourth embodiment will be described. The fourth embodiment is basically the same as the first embodiment in configurations and operations, and is different from the first embodiment in that the light amount control function is switched on and off according to the purpose of use of the user. Therefore, the descriptions about the same configurations and operations will be omitted, and the different configurations and operations will be described below.

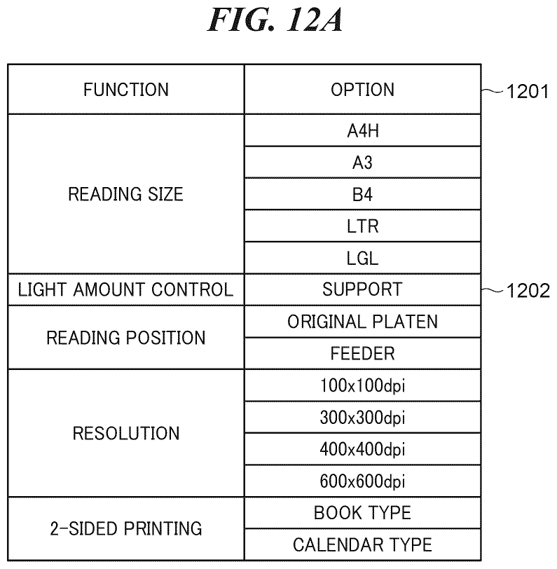

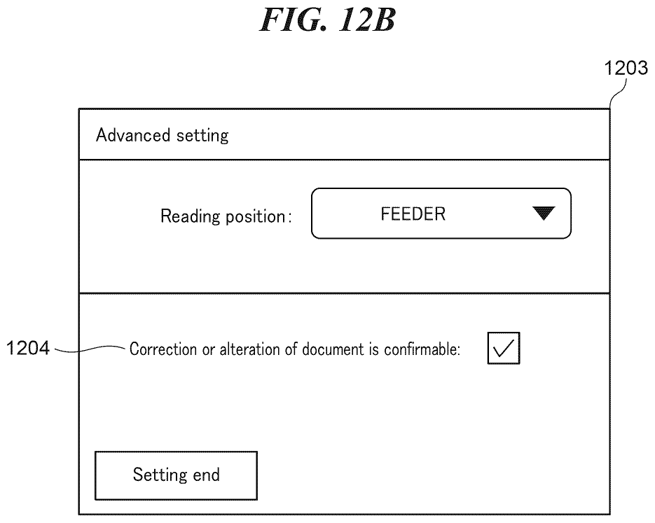

FIG. 12A is a view illustrating an example of a list of pieces of capability information obtained from the scanning apparatus 102 according to the fourth embodiment. As shown in a table 1201 in FIG. 12A, the capability information obtained from the scanning apparatus 102 records information indicating whether the light amount control function is supported or not supported is recorded as an option of the light amount control instead of settable numerical values (control levels). In FIG. 12A, the information 1202 indicating that the scanning apparatus 102 supports the light amount control function is recorded.

FIG. 12B is a view illustrating an example of an advanced setting screen 1203 in which the set state of the light amount control function can be set by a use case name.

In the fourth embodiment, when the information 1202 indicating that the light amount control function is supported is recorded in the capability information obtained from the scanning apparatus 102, the expansion application 204 causes the display unit 119 to display the advanced setting screen 1203 in accordance with the display request of the advanced setting screen received from the user. The advanced setting screen 1203 includes a control 1204 having a use case name “Correction or alteration of document is confirmable”. When the user selects the control 1204 by checking a check box as shown in FIG. 12B, the expansion application 204 generates a scan instruction command in accordance with the scan instruction by the user. The expansion application 204 transmits (outputs) the scan instruction command to the scanning apparatus 102. The scan instruction command includes a set state of the light amount control function to control the light amount to be different from a reference light amount. For example, a dark light amount is set so that image data in a state where correction traces on the document due to correction liquid or correction tape are visually recognizable will be obtained.

On the other hand, when the information 1202 indicating that the light amount control function is supported is not recorded in the capability information obtained from the scanning apparatus 102, the advanced setting screen 305a in FIG. 3B that does not include the control 1204 is displayed on the display unit 119 in accordance with the display request of the advanced setting screen received from the user.

As described above, in the fourth embodiment, when the information 1202 indicating that the light amount control function is supported is recorded in the capability information obtained from the scanning apparatus 102, the advanced setting screen 1203 including the control 1204 is displayed. That is, only when the scanning apparatus 102 supports the light amount control function, the advanced setting screen 1203 including the control 1204 for setting the light amount control is displayed. This prevents the set state of the light amount control function from transmitting to a scanning apparatus that does not support the light amount control function.

In the fourth embodiment described above, the advanced setting screen 1203 including the control 1204 for setting valid or invalid of a document correction/alteration confirmation function using the light amount control function (a predetermined function that needs to change a light amount in a scanning process from the default light amount) is displayed on the display unit 119. When the document correction/alteration confirmation function is set to be valid on the advanced setting screen 1203, the scan instruction command for causing the scanner to execute the scanning process with a light amount different from the reference light amount is output. This allows the user to use the light amount control function.

Further, since the control 1204 is the use case name, the user can use the light amount control function in an easily understandable manner.

In the present embodiment, even when the capability information including the numerical value that can be set as the option of the light amount control is obtained from the scanning apparatus 102, the advanced setting screen 1203 including the control 1204 of the use case name described above may be displayed on the display unit 119.

Next, a communication system, an information processing apparatus, and a control method for the information processing apparatus according to a fifth embodiment will be described. The fifth embodiment is basically the same as the first embodiment in configurations and operations, and is different from the first embodiment in that the scanning apparatus 102 further supports a background control function. Therefore, the descriptions about the same configurations and operations will be omitted, and the different configurations and operations will be described below.

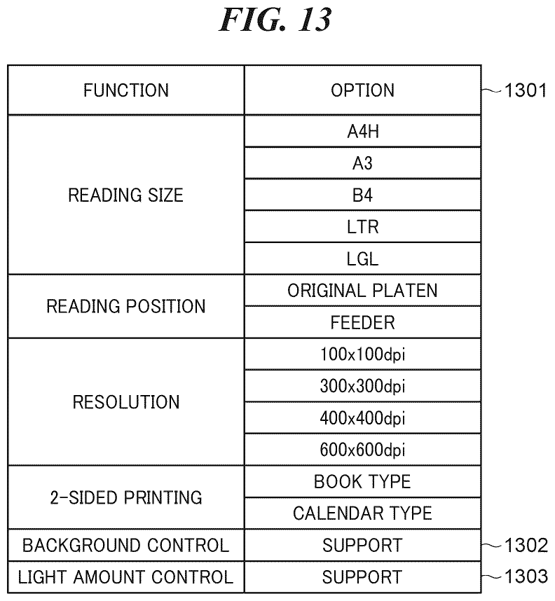

FIG. 13 is a view illustrating an example of a list of pieces of capability information obtained from the scanning apparatus 102 according to the fifth embodiment. As illustrated in a table 1301 in FIG. 13, the capability information obtained from the scanning apparatus 102 includes information 1302 indicating that the scanning apparatus 102 supports the background control function in addition to information 1303 indicating that the scanning apparatus 102 supports the light amount control function. The background control function is a function of erasing a color of a background in image data obtained by scanning a document.

The user who sets the document correction/alteration confirmation function is considered to want to obtain image data in a state where correction traces on the document due to correction liquid or correction tape are visually recognized. However, the image data required by the user cannot be obtained if the background is erased by the background control function. In contrast, the present embodiment controls so that the document correction/alteration confirmation function using the light amount control function and the background control function are not both (simultaneously) set to be valid.

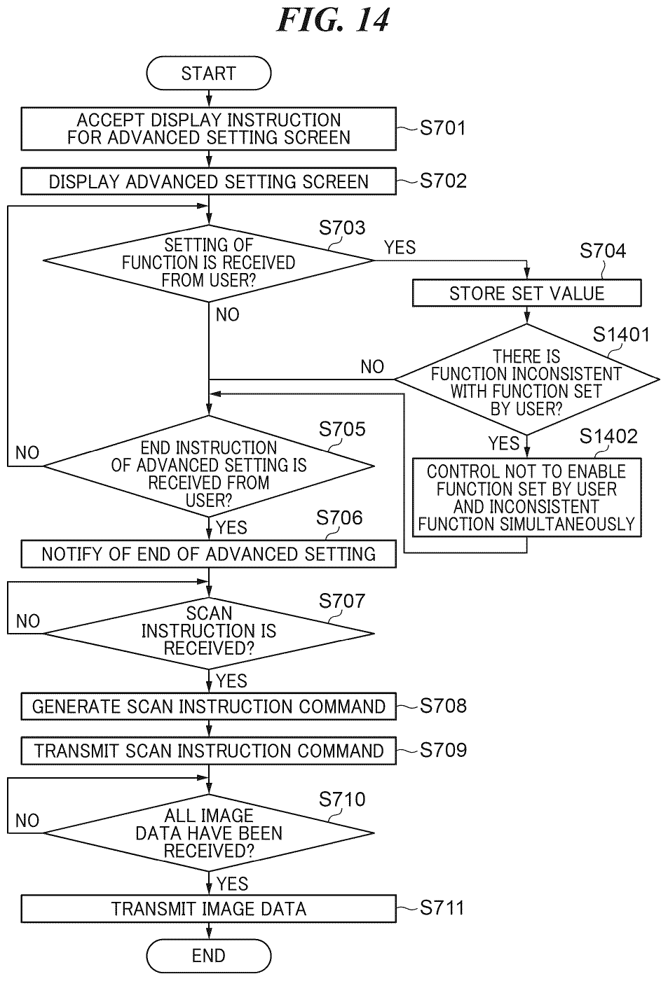

FIG. 14 is a flowchart illustrating a scan instruction command generation process executed by the expansion application 204 according to the fifth embodiment. The scan instruction command generation process in FIG. 14 is similar to the scan instruction command generation process in FIG. 7, and the following description will be focused on the differences from the scan instruction command generation process in FIG. 7. The scan instruction command generation process in FIG. 14 is also achieved by the CPU 111 executing the program of the expansion application 204 read from the external storage device 114 to the RAM 113 as with the scan instruction command generation process in FIG. 7 described above.

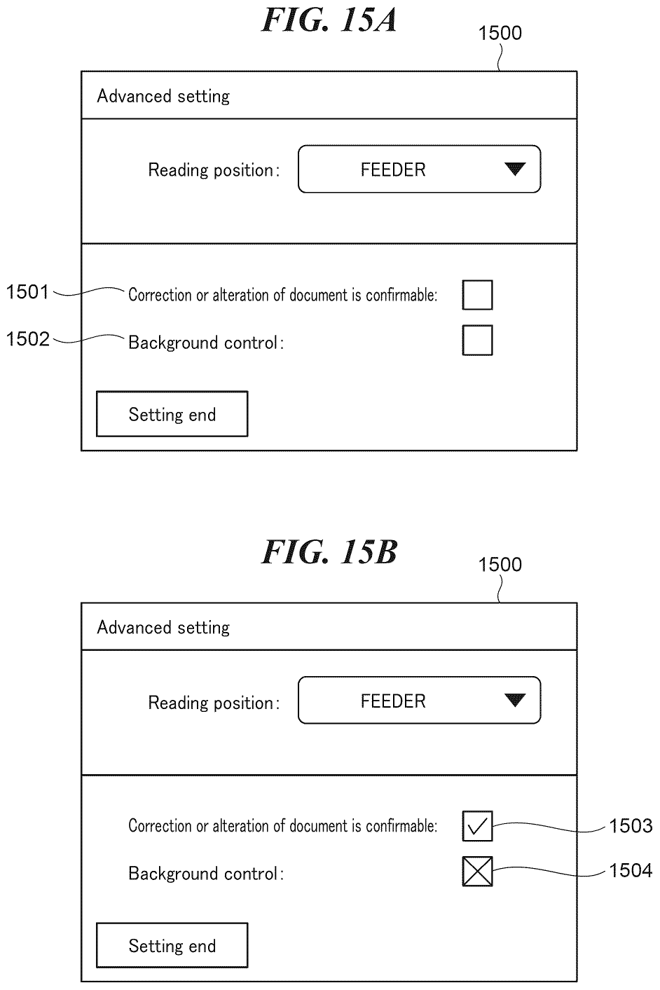

In FIG. 14, the process from S701 to S702 described above is performed first. In S702, an advanced setting screen 1500 in FIG. 15A is displayed on the display unit 119 with reference to the scan capability generated based on the scan function information 203 to which the information 1302 and the information 1303 are added in the above-described editing control processing in FIG. 4. The advanced setting screen 1500 includes a control 1502 for switching ON/OFF of the background control function in addition to a control 1501 having the same function as the control 1204 described above. Next, the process in S703 is performed.

When it is determined in S703 that a setting of a function is received from the user on the advanced setting screen 1500, the process proceeds to S704. The expansion application 204 stores in S704 a set value set on the advanced setting screen 1500 in the RAM 113.

Next, the scan-setting-screen expansion unit 205 of the expansion application 204 determines in S1401 whether there is another function inconsistent with the function set by the user in S703 among the functions that can be set on the advanced setting screen 1500. As shown in FIG. 15A, ON/OFF of the document correction/alteration confirmation function and ON/OFF the background control function can be set to ON/OFF are switchable on the advanced setting screen 1500. However, when both the document correction/alteration confirmation function and the background control function are set to ON (valid), inconsistency occurs. When the function set by the user in S703 is any of the document correction/alteration confirmation function and the background control function, it is determined in S1401 that there is another function inconsistent with the function set by the user in S703 among the functions that can be set on the advanced setting screen 1500. In this case (YES in S1401), the process proceeds to S1402.

The scan-setting-screen expansion unit 205 controls in S1402 so as not to enable the function set by the user in S703 and the other inconsistent function simultaneously. For example, when the user checks a check box 1503 in S703 to enable the document modification/alteration confirmation function, a check box 1504 for the control 1502 of the background control function is uncheckable as shown in FIG. 15B and the background control function is set to be invalid. During such control, it may be controlled so that the user cannot select the control 1502 of the background control function set to be invalid. Note that if the document correction/alteration confirmation function is not set (invalid), i.e., if the check box 1503 is not checked, the user can enable the background control function by checking the check box 1504 for the control 1502 of the background control function. The process then proceeds to S705.

When it is determined in S703 that setting of a function is not received from the user on the advanced setting screen 1500, the process also proceeds to S705. Thereafter, the process from S706 to S711 is performed, and the present process ends.

As described above, the fifth embodiment controls so that the document modification/alteration confirmation function using the light amount control function and the background control function are not enabled simultaneously. This prevents the user from erroneously setting both of these functions to be valid, which avoids occurrence of inconsistency.

In the fifth embodiment described above, control other than the control described above may be performed as long as generation of a scan instruction command enabling both the document correction/falsification confirmation function and the background control function can be prevented. For example, when the user enables the document correction/alteration confirmation function in S703, a scan instruction command for executing the background control function with the minimum set value at which the background control is disabled may be generated.

In the fifth embodiment described above, a function other than the background control function that is inconsistent with the document correction/alteration confirmation function may be controlled so as not to be enabled together with the document correction/alteration confirmation function.

In the fifth embodiment described above, when the user enables both the document correction/alteration confirmation function and the background control function on the advanced setting screen 1500, a message indicating that both of the functions cannot be enabled simultaneously on the display unit 119.

In the fifth embodiment described above, at least one of a set state of a newly enabled function and a set state of a function that cannot be enabled together with the newly enabled function can be changed on the UI screen. For example, when the user enables the control 1501 on the advanced setting screen 1500 in a state where the control 1502 is enabled, the control 1502 is changed to be invalid or both the controls 15101 and 1502 are changed to be invalid. When such control is performed, a message indicating that these functions cannot be enabled simultaneously may be displayed on the display unit 119.

In the fifth embodiment described above, the set state may be changed internally when the scan instruction command is generated after the setting on the advanced setting screen 1500 is finished without controlling the display on the advanced setting screen 1500. For example, when both the controls 1501 and 1502 are enabled, a scan instruction command including only the set state of the document correction/alteration confirmation function among the document correction/alteration confirmation function and the background control function may be generated.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-044636, filed Mar. 21, 2024, which is hereby incorporated by reference herein in its entirety.

What is claimed is:

1. A non-transitory computer-readable storage medium storing a program that supports a general-purpose program capable of commonly being used in scanning apparatuses of a plurality of manufactures and causes an information processing apparatus into which the program is installed to execute a method comprising:
displaying a setting screen on which a set state of a light amount in a scanning process is accepted; and
outputting a command to cause a scanning apparatus to execute the scanning process with the set state of the light amount accepted on the setting screen.

2. The non-transitory computer-readable storage medium according to claim 1, wherein a user is allowed to select one set value from among a plurality of set values corresponding different light amounts on the setting screen.

3. The non-transitory computer-readable storage medium according to claim 1, wherein a user is allowed to set a numerical value indicating a ratio to a predetermined light amount on the setting screen.

4. The non-transitory computer-readable storage medium according to claim 1, wherein a user is allowed to set a numerical value indicating a light amount on the setting screen.

5. The non-transitory computer-readable storage medium according to claim 1, wherein the method further includes generating a command for causing the scanning apparatus to execute the scanning process with the set state of the light amount accepted on the setting screen.

6. The non-transitory computer-readable storage medium according to claim 5, wherein the command is generated by expanding a function of a command conforming to a standard protocol.

7. The non-transitory computer-readable storage medium according to claim 5, wherein the command is generated by converting a command conforming to a standard protocol into a command system unique to the program.

8. The non-transitory computer-readable storage medium according to claim 1, wherein the method further includes:
generating a first command conforming to a standard protocol; and
generating a second command including the set state of the light amount in the scanning process.

9. The non-transitory computer-readable storage medium according to claim 1, wherein the method further includes editing a command, which is generated by the general-purpose program and causes the scanning apparatus to execute the scanning process, so as to add the set state of the light amount accepted on the setting screen.

10. The non-transitory computer-readable storage medium according to claim 1, wherein the method further includes obtaining capability information from a scanning apparatus connected to the information processing apparatus, wherein
when the capability information obtained includes information indicating that the scanning apparatus supports a function of controlling the light amount in the scanning process, the setting screen is displayed on a display unit of the information processing apparatus, and
when the capability information obtained does not include the information indicating that the scanning apparatus supports the function of controlling the light amount in the scanning process, another setting screen excluding a setting item of the light amount in the scanning process is displayed on the display unit of the information processing apparatus.

11. A non-transitory computer-readable storage medium storing a program that supports a general-purpose program capable of commonly being used in scanning apparatuses of a plurality of manufactures and causes an information processing apparatus into which the program is installed to execute a method comprising:
displaying a setting screen on which valid or invalid of a predetermined function that needs to change a light amount in a scanning process from a default light amount is set is displayed on a display unit of the information processing apparatus; and
outputting a command to cause a scanning apparatus to execute the scanning process with the light amount different from the default light amount when the predetermined function is set to be valid on the setting screen.

12. The non-transitory computer-readable storage medium according to claim 11, wherein valid or invalid of another function that is inconsistent with the predetermined function can be set on the setting screen, and
wherein the method further includes controlling to prevent the predetermined function and the other function from being set to be valid simultaneously.

13. The non-transitory computer-readable storage medium according to claim 11, wherein valid or invalid of another function that is inconsistent with the predetermined function can be set on the setting screen, and
wherein the method further includes controlling to prevent generation of a command enabling both the predetermined function and the other function.

14. The non-transitory computer-readable storage medium according to claim 1, wherein the method further includes:
receiving image data generated by the scanning process from the scanning apparatus; and
displaying the image data as a preview image on a display unit of the information processing apparatus.

15. The non-transitory computer-readable storage medium according to claim 14, wherein the preview image can be edited.

16. A control method for an information processing apparatus into which a program that supports a general-purpose program capable of commonly being used in scanning apparatuses of a plurality of manufactures is installed, the control method comprising:
displaying a setting screen on which a set state of a light amount in a scanning process is accepted; and
outputting a command to cause a scanning apparatus to execute the scanning process with the set state of the light amount accepted on the setting screen.

17. A control method for an information processing apparatus into which a program that supports a general-purpose program capable of commonly being used in scanning apparatuses of a plurality of manufactures is installed, the control method comprising:
displaying a setting screen on which valid or invalid of a predetermined function that needs to change a light amount in a scanning process from a default light amount is set is displayed on a display unit of the information processing apparatus; and
outputting a command to cause a scanning apparatus to execute the scanning process with the light amount different from the default light amount when the predetermined function is set to be valid on the setting screen.

18. An information processing apparatus into which a program that supports a general-purpose program capable of commonly being used in scanning apparatuses of a plurality of manufactures, the information processing apparatus comprising:
a display unit;
a memory device that stores a set of instructions; and
at least one processor that executes the set of instructions to:
display a setting screen on which a set state of a light amount in a scanning process is accepted; and
output a command to cause a scanning apparatus to execute the scanning process with the set state of the light amount accepted on the setting screen.

19. An information processing apparatus into which a program that supports a general-purpose program capable of commonly being used in scanning apparatuses of a plurality of manufactures, the information processing apparatus comprising:
a display unit;
a memory device that stores a set of instructions; and
at least one processor that executes the set of instructions to:
display a setting screen on which valid or invalid of a predetermined function that needs to change a light amount in a scanning process from a default light amount is set is displayed on a display unit of the information processing apparatus; and
output a command to cause a scanning apparatus to execute the scanning process with the light amount different from the default light amount when the predetermined function is set to be valid on the setting screen.
